(19) United States
(12) Patent Application Publication
(10) Pub. No.: US 2015/0197879 A1
(43) Pub. Date: Jul. 16, 2015

(54) DEVICE FOR WEAVING

(71) Applicant: Wooky Entertainment Inc., Montreal (CA)

(72) Inventors: Kevin RICHER, St-Bruno-De-Montarville (CA); Guillaume GUYADER, Verdun (CA); Dominique ROY, St-Lazare (CA)

(21) Appl. No.: 14/304,201

(22) Filed: Jun. 13, 2014

Related U.S. Application Data
(60) Provisional application No. 61/925,717, filed on Jan. 10, 2014.

(51) Int. Cl. D03D 51/02; D03J 1/00; G05B 15/02

(52) U.S. Cl. CPC D03D 51/02; G05B 15/02; D03J 1/005

(57) ABSTRACT

A device for making a woven article from a plurality of strings includes a housing, a computing device, a first engagement device, and a sensor assembly. The computing device is supported by the housing and includes a display. The first engagement device is coupled to the housing and operable to engage a plurality of strings. The sensor assembly is coupled to the housing and is operable to engage the computing device. The computing device is operable to communicate instructions for manipulating the plurality of strings.

### CROSS-REFERENCE TO RELATED APPLICATIONS

This application claims the benefit of U.S. Provisional Application No. 61/925,717, filed on Jan. 10, 2014. The entire disclosure of the above application is incorporated herein by reference.

### FIELD

The present disclosure relates to a device for making a woven article.

### BACKGROUND

This section provides background information related to the present disclosure and is not necessarily prior art.

Crafting woven articles such as friendship bracelets, necklaces or belts, for example, can be a fun and enjoyable hobby or occupation. Such articles can be made by weaving and tying thread and/or yarn of one or more colors in a desired pattern. While devices have been provided in the past that allow a person to weave a friendship bracelet according to a predetermined pattern, template or instructions, a device that allows a person to interact with the pattern, template or instructions in a real time manner as each is provided via a computing device, should improve the process of crafting such articles.

### SUMMARY

This section provides a general summary of the disclosure, and is not a comprehensive disclosure of its full scope or all of its features.

The present disclosure provides a device for making a woven article from a plurality of strings. The device includes a housing, a computing device, an engagement device, and a sensor assembly. The computing device is removably coupled to the housing. The engagement device is coupled to the housing and operable to engage a plurality of strings. The sensor assembly is coupled to the housing and is operable to engage the computing device. The computing device is operable to display instructions for manipulating the plurality of strings.

According to another particular aspect, the present disclosure provides a device for making a woven article from a plurality of strings. The device includes a housing, a computing device, a first engagement device and a second engagement device. The housing includes a window. The computing device is removably coupled to the housing and includes a display. The display is viewable through the window. The first engagement device is coupled to a first end of the housing and is operable to engage a plurality of strings. The second engagement device is coupled to a second end of the housing and is operable to engage the plurality of strings. The plurality of strings extends across the display.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a device for making a woven article according to the principles of the present disclosure;

FIG. 2 is a top view of another configuration a device for making a woven article according to the principles of the present disclosure;

FIG. 3 is a top view of an engagement device of the device of FIGS. 1 and 2, showing the engagement device in an unlocked position;

FIG. 4 is a top view of a pattern or template for creating a woven article with the device of FIGS. 1 and 2;

FIG. 5 is a top view of another configuration of a device for making a woven article according to the principles of the present disclosure;

FIG. 6 is a perspective view of the device of FIG. 5, showing a plurality of threads installed in the device;

FIG. 7 is a partially exploded view of the device of FIG. 5;

FIG. 8 is a perspective view of another configuration of a device for making a woven article according to the principles of the present disclosure;

FIG. 9 is a partially exploded view of the device of FIG. 8;

FIG. 10 is a top view of the device of FIG. 8;

FIG. 11 is a perspective view of another configuration of a device for making a woven article according to the principles of the present disclosure;

FIG. 12 is a partially exploded view of the device of FIG. 11;

FIG. 13 is a top view of the device of FIG. 11;

FIG. 14 is a top view of another configuration of a device for making a woven article according to the principles of the present disclosure;

FIG. 15 is a bottom view of the device of FIG. 14;

FIG. 16 is bottom view of the device of FIG. 14, with a computing device removed to show a cavity of the device;

FIG. 17 is a partially exploded view of the device of FIG. 14;

FIG. 18 is a top view of another configuration of a device for making a woven article according to the principles of the present disclosure, the device shown in a first arrangement;

FIG. 19 is another top view of the device of FIG. 18, the device shown in a second arrangement;

FIG. 20 is another top view of the device of FIG. 18, the device shown in a third arrangement;

FIG. 21 is a perspective view of the device of FIG. 18, the device shown in a fourth arrangement; and

FIG. 22 is a partially exploded view of the device of FIG. 18.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

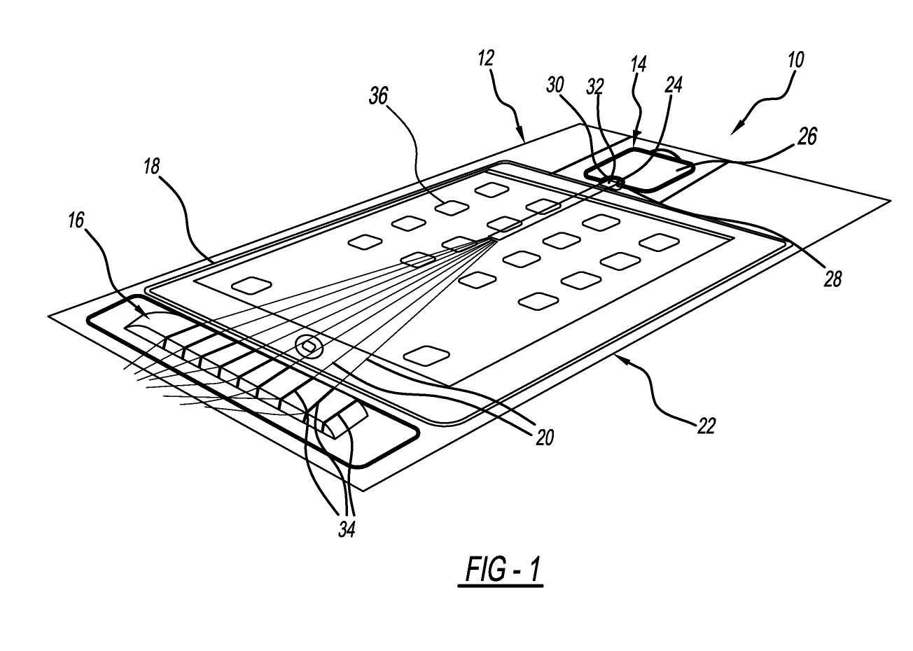

With reference to FIG. 1, a device 10 for making a woven article is provided. The device 10 includes a housing or base 12, a first engagement device 14, and a second engagement device 16. The device 10 may be used with a computing device 18 to make woven articles, such as friendship bracelets and/or necklaces, for example, from a plurality of strings 20. The computing device 18 may be a portable computing device such as a tablet computer (e.g., IPAD®, KINDLE®, NOOK®, etc.). The term “string,” as used herein, refers to thread, yarn, cord, line, twine, or elastic bands, for example, or any other material that can be used for weaving, twisting, tying and/or sewing, for example.

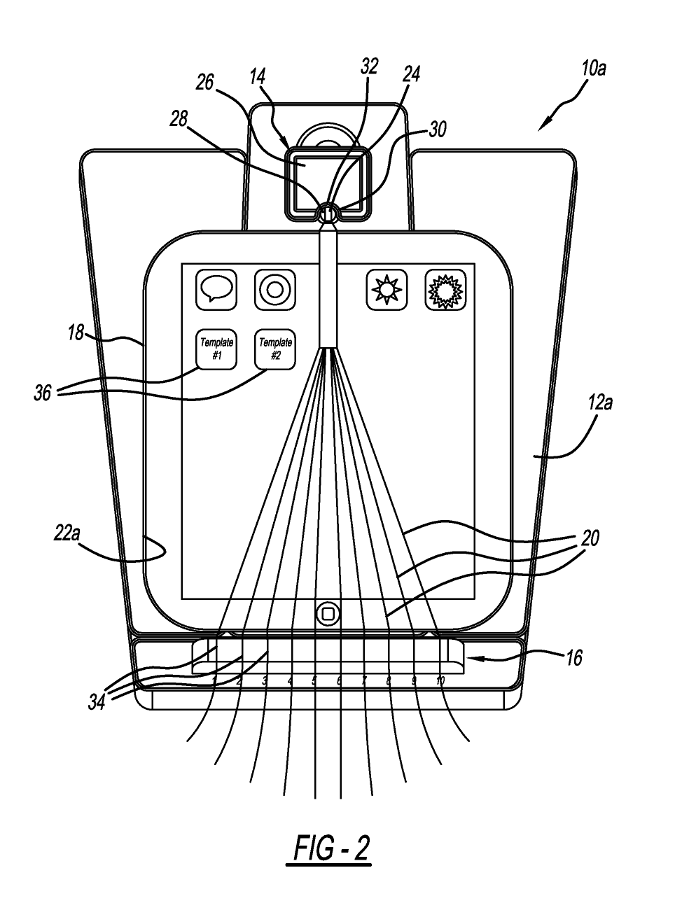

In one configuration, the base 12 may define an area 22 between the first engagement device 14 and the second engagement device 16 that is recessed relative to the height of the first and second engagement devices 14, 16. With reference to FIG. 2, another configuration of a device 10a may include a base 12a. The device 10a may be substantially similar to the device 10, except as otherwise provided herein. Accordingly, like reference numerals will be used to describe similar features. The base 12a of the device 10a may define a cavity 22a. The cavity 22a may be located between the first engagement device 14 and the second engagement device 16, and generally sized to fit and hold the computing device 18 on the base 12a. In this regard, it will be appreciated that at least one dimension (length or width, for example) of the cavity 22a may be smaller than a corresponding dimension of the computing device 18, such that the computing device 18 is secured within the cavity 22a by friction or an interference fit.

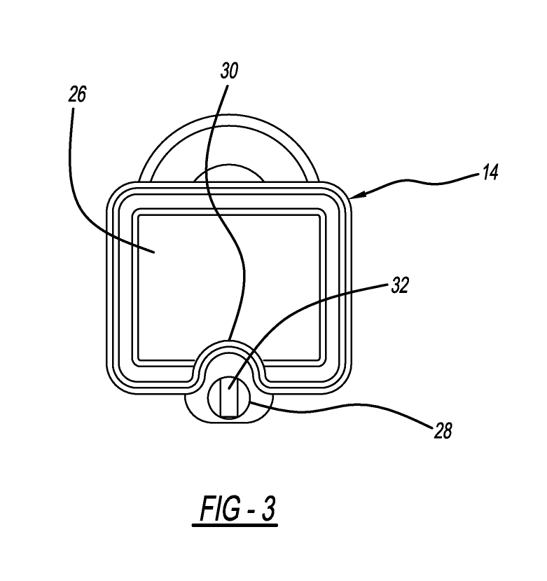

The first engagement device 14 secures first ends 24 of the strings 20 and includes a locking member 26 and a post 28. The locking member 26 is fixedly attached to the base 12 and may include a notch 30. The post 28 may include a slot 32 and may be coupled to the locking member 26 for movement relative to the locking member 26 between a locked position (FIG. 2) and an unlocked position (FIG. 3). When the post 28 is in the unlocked position, the first ends 24 of the strings 20 can be looped around the post 28 and through the slot 32. Then, the post 28 is moved to the locked position to secure the first ends 24 of the strings 20. In the locked position, the post 28 is nested in the notch 30 of the locking member 26. With the post 28 received in the notch 30, the first ends 24 of the strings 20 are restricted or prevented from disengaging the post 28. In some embodiments, friction or interference between the post 28 and the locking member 26 may retain the post 28 in the locked position to prevent unintentional movement of the post 28 into the unlocked position. In some embodiments, the post 28 may be spring-biased toward the locked position to prevent unintentional movement of the post 28 into the unlocked position.

The second engagement device 16 may be an elongated foam or rubber member fixedly attached to the base 12 and extending in a direction that is substantially perpendicular to a length or a width of the computing device 18. As illustrated, in one configuration, the second engagement device 16 extends in a direction that is perpendicular to the length of the computing device 18. The second engagement device 16 may include a plurality of slits 34 formed therein. The slits 34 may be parallel to each other and perpendicular to the elongated direction of the second engagement device 16. Each of the slits 34 removably engages a corresponding one of the strings 20. The first and second engagement devices 14, 16 cooperate to hold the strings 20 in a generally taught condition, as shown in FIGS. 1 and 2.

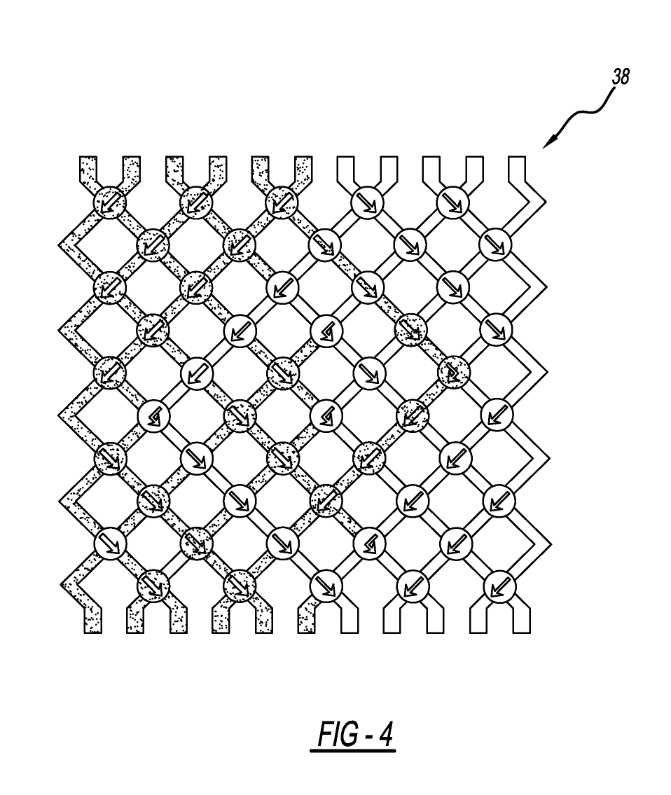

With continued reference to FIGS. 1-4, a method of using the device 10 will be described. First, the computing device 18 is placed on the base 12. As described above, in one configuration, the computing device 18 may be placed and/or secured within the cavity 22a defined by the base 12a. In another configuration, the computing device 18 may be placed and/or secured within the area 22 delimited on opposing ends by the first engagement device 14 and the second engagement device 16. Next, with the first engagement device 14 in the unlocked configuration (e.g., with the post 28 in the unlocked position), the ends 24 of the strings 20 are attached to the first engagement device 14 by looping and and/or tying the ends 24 around the post 28. Then, the user may move the post 28 to the locked position to fixedly secure the ends 24 to the first engagement device 14, thereby fixing the ends 24 relative to the base 12. Next, portions of each string 20 distal from the ends 24 may be received in a corresponding slit 34 in the second engagement device 16 so that the strings 20 are held in a taught condition between the first and second engagement devices 14, 16. Before or after placing the strings 20 in the slits 34, by accessing the internet, an application 36, or another electronic document on the computing device 18, the user may select a set of instructions for creating a woven article. The instructions may take the form of a pictorial pattern or template 38, textual instructions, video instructions, or audio instructions. Selecting the application 36 may cause the instructions, including the pattern or template 38, to appear on a screen or display (e.g., an LED or LCD) of the computing device 18. It will also be appreciated that, in addition to or in lieu of selecting the instructions via the application 36, the user may select instructions for creating the woven article by accessing the internet, or another electronic document on the computing device 18.

Prior to beginning the weaving process, the user may input, or otherwise indicate to the computing device 18, the colors of the strings 20 that the user has attached to the device 10. Indicating the color of the strings 20 may allow the instructions, including the template 38, to display such colors, or a textual representation of such colors, on the computing device 18. With the first engagement device 14 fixed in place, the strings 20 in the taught condition, and the template 38 or other instructions displayed on the computing device 18, the user may begin weaving or otherwise manipulating the strings 20 in accordance with the template or instructions to create the woven article. After the user completes a step A in the instructions, the user may push a button or icon on the computing device 18 such that the computing device 18 sends a signal to display a step B in the instructions. In this way, the user is able to create the woven article while interacting with the instructions or template 38 in a real-time manner.

When the user has finished weaving the strings 20, the user may remove the strings 20 from the slits 34 in the second engagement device 16 and tie the strings 20 in a knot to prevent the strings 20 from unweaving. Any unwoven portion of the strings 20 can also be trimmed off using scissors, for example. The ends 24 of the strings 20 can be removed from the first engagement device 14 by moving the post 28 into the unlocked position and sliding the ends 24 off of the post 28.

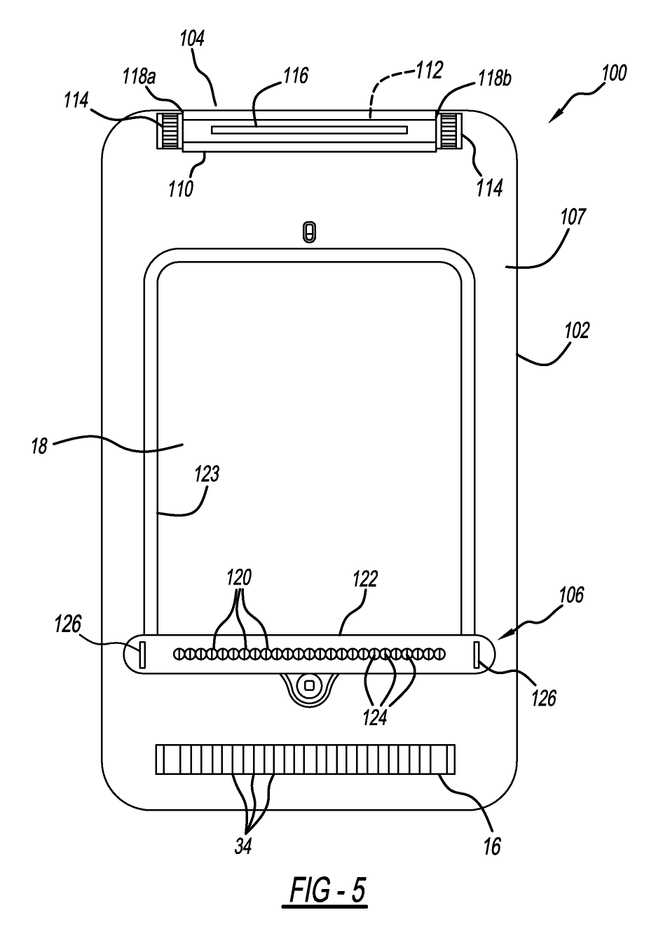

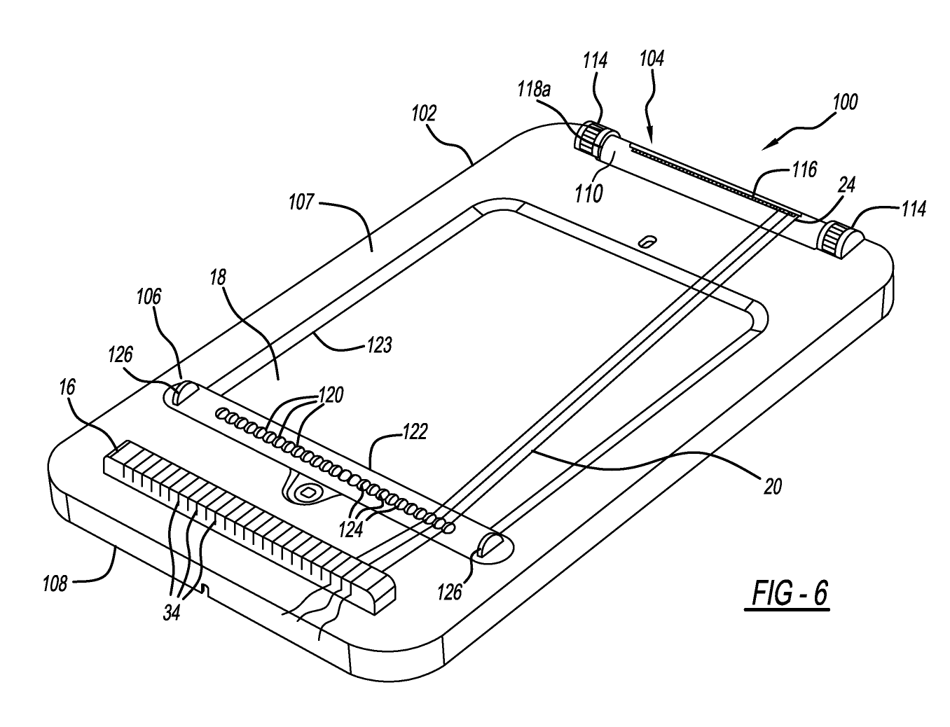

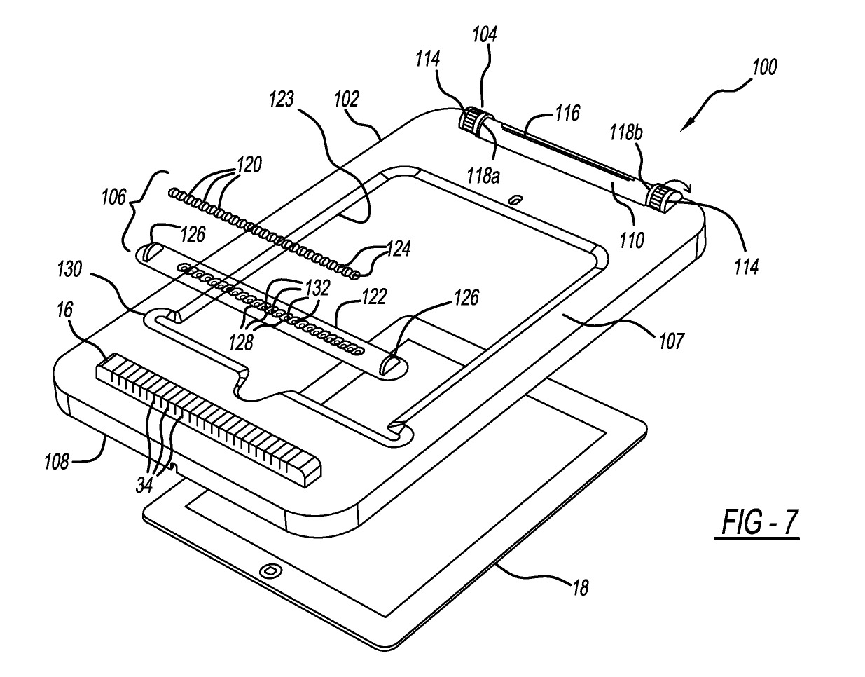

With reference to FIGS. 5-7, another configuration of a device 100 for making a woven article is provided. The device 100 may be substantially similar to the device 10, except as otherwise provided herein. Accordingly, like reference numerals will be used to describe similar parts and features. The device 100 includes a base 102, a first engagement device 104, the second engagement device 16, and a sensor assembly 106. The first and second engagement devices 102, 16 are disposed on a first side 107 of the device 100.

The base 102 of the device 100 may define a window or aperture 123. The aperture 123 may be sized and shaped such that the computing device 18 is visible therethrough. In one configuration, a second side 108 (opposite the first side 107) of the device 100 may define a cavity (not shown) sized and shaped to receive and/or support the computing device 18. In this regard, it will be appreciated that at least one dimension (length or width, for example) of the cavity may be smaller than a corresponding dimension of the computing device 18, such that the computing device 18 is secured within the cavity by friction or an interference fit.

The first engagement device 104 secures first ends 24 of the strings 20 and includes a hub 110, an axle 112 and at least one wheel member 114. In one configuration, the hub 110 may be integrally and monolithically formed with the base 102 and extend longitudinally in a direction generally parallel to the second engagement device 16. The hub 110 may include a longitudinally extending slot 116 and first and second openings (not shown) at first and second longitudinal ends 118a, 118b of the hub 110.

The axle 112 may be rotatably housed within the hub 110. In this regard, the axle 112 may extend longitudinally within the hub 110 between first and second longitudinal ends (not shown). The strings 20 may be wrapped around the axle 112 any number of revolutions and extend through the slot 116 of the hub 110. Accordingly, the user can vary the length of the strings 20 extending from the axle 112 and the slot 116 by rotating the axle and winding or unwinding the strings 20 therefrom.

The at least one wheel member 114 may be mounted to one of the first and second longitudinal ends of the axle 112. As illustrated, in one configuration, the first engagement device 104 includes two wheel members 114 disposed at the first and second longitudinal ends of the axle 112. Accordingly, the wheel members 114 allow the user to rotate the axle 112 and wind or unwind the strings 20 therefrom, such that the weaving occurs in a preselected area, generally aligned with the screen or display of the computing device 18.

The sensor assembly 106 may include a plurality of actuation elements 120 and a tray 122. In one configuration, the sensor assembly 106 includes twenty-five actuation elements 120. It will be appreciated, however, that the sensor assembly 106 may include more or less than twenty-five actuation elements 120 within the scope of the present disclosure. The actuation elements 120 may include capacitive properties. Each of the plurality of actuation elements 120 may be fixed to one of the strings 20. In this regard, the actuation element 120 may include an aperture or slot 124 for slidably receiving a string 20. The actuation elements 120 may be formed from an inductive material. As illustrated, in one configuration, the actuation elements 120 are generally spherically shaped. It will also be appreciated, however, that the actuation elements may include other shapes such as cylindrical, cubical, or egg-shaped, within the scope of the present teachings.

The tray 122 may include at least one handle element 126 and a plurality of divots 128. The base 112 may include a recessed portion 130 sized and shaped to receive the tray 122, such that the tray 122 is disposed generally adjacent to the screen or display of the computing device 18. The at least one handle element 126 may be integrally formed with the tray 122 and extend generally perpendicularly therefrom, such that the user can hold the handle element 126 to position the tray 122 within the recessed portion 130 of the base 102. As illustrated, in one configuration, the plurality of divots 128 defines a linear pattern extending longitudinally along the tray 122. The linear pattern of divots 128 may be generally parallel to the second engagement device 16 and the slot 116 in the hub 110. It will be appreciated that in other configurations the plurality of divots 128 may define an arcuate pattern along the tray 122. Each divot 128 may include an aperture 132 extending therethrough. The aperture 132 may extend in a direction generally parallel to the normal of the screen or display of the computing device 18. Each divot 128 may be sized and shaped to removable receive one of the actuation elements 120. In this regard, in one configuration, the divots 128 may include a generally hemispherical surface. The aperture 132 may be sized and shaped such that the actuation element 120 is operable to contact the screen or display of the computing device 18 when the actuation element 120 is located within the divot 128.

With continued reference to FIGS. 5-7, a method of using the device 10 will be described. As described above, in one configuration, the computing device 18 may be placed and/or secured within the cavity defined in the second side 108 of the base 102. Next, the ends 24 of the strings 20 are attached to the first engagement device 104 by winding the strings around the axle 112. Each string 20 may be extended through the slot 116 of the hub 110 by unwinding the string 20 from the axle 112, and may further be received in a corresponding slot 124 of the actuation element 120. Thereafter, each string 20 is received in respective slit 34 of the second engagement device 16 so that the strings 20 are held in a taught condition between the first and second engagement devices 104, 16. Before or after placing the strings 20 in the slits 34, by accessing the internet, an application 36, or another electronic document on the computing device 18, the user may select a template 38 or a set of instructions for creating a woven article. The instructions or template 38 may appear on the screen or display of the computing device 18 as text, video, or pictorial instructions that the user can read or watch while creating the woven article.

With the template or instructions displayed on the computing device 18, the user may begin weaving the strings 20 in accordance with the template or instructions. To complete a step in the template or instructions, the user will remove a string 20 from the slit 34, and accordingly remove the actuation element 120 from the divot 128. When the actuation element 120 is removed from the divot 128, the screen or display of the computing device 18 may sense that the actuation element 120 is no longer contacting the screen or display through the aperture 132. In this way, the computing device 18 is able to sense that the user is in the process of completing a step in the template or instructions. Upon completion of the step, the user may place the string 20 in a slit 34 of the second engagement device 16, and accordingly place the actuation element 120 in a divot 128. When the actuation element 120 is placed in the divot 128, the screen or display of the computing device 18 may sense through the aperture 132 that the actuation element 120 is located within the divot 128. In this way, the computing device 18 is able to sense that the user has completed the step in the template or instructions, and send a corresponding signal to the application 36 or other software. Upon receiving the signal that the corresponding step in the template or instructions is complete, the application 36 or other software may cause the computing device 18 to display the next step in the template or instructions. In this way, the user is able to create the woven article while interacting with the instructions or template 38 in a real-time manner. As the user completes the weaving process, a distance between the actuation element 120 and the engagement device 104 may decrease, such that the actuation element 120 is not aligned with the corresponding divot 128. In this regard, it will be appreciated that the string 20 may be slidably mounted within the slot 124 of the actuation element 120, such that the user can maintain the alignment between the divot 128 and the actuation element 120 by sliding the actuation element 120 along the string 20.

When the user has finished weaving the strings 20, the user may remove the strings 20 from the slits 34 in the second engagement device 16 and tie the strings 20 in a knot to prevent the strings 20 from unweaving. Any unwoven portion of the strings 20 can also be trimmed off using scissors, for example. In addition, if the user decides to stop working on the woven article, the user may remove the computing device 18 from the second side 108 of the base 102, such that the woven article remains fixed to first side 107 of the base 102. In this way, the user can remove and replace the computing device 18 from the base 102 without disrupting the work already completed on the woven article.

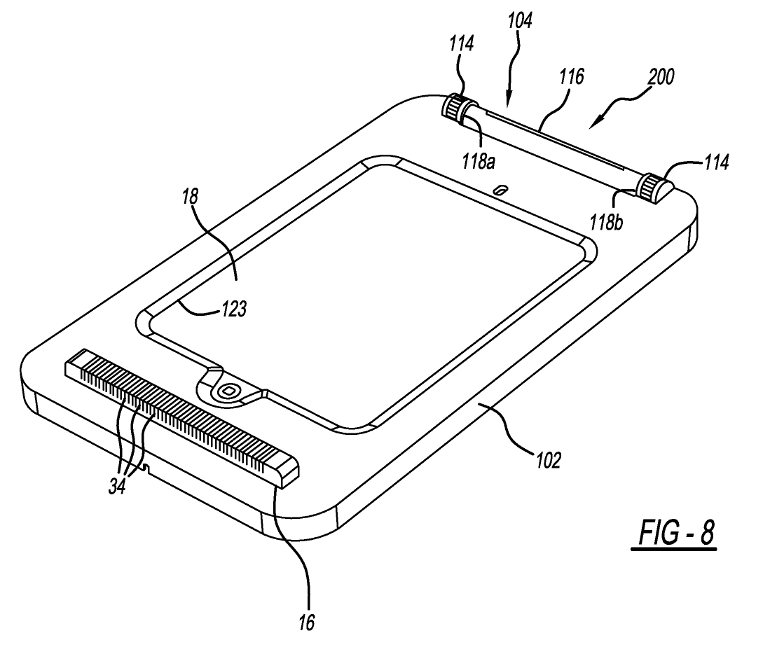

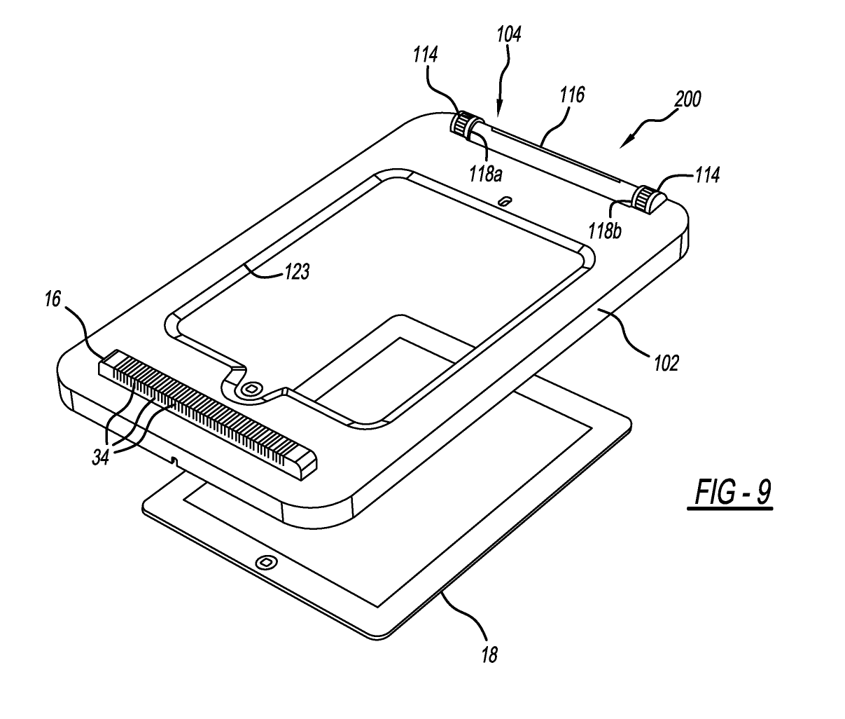

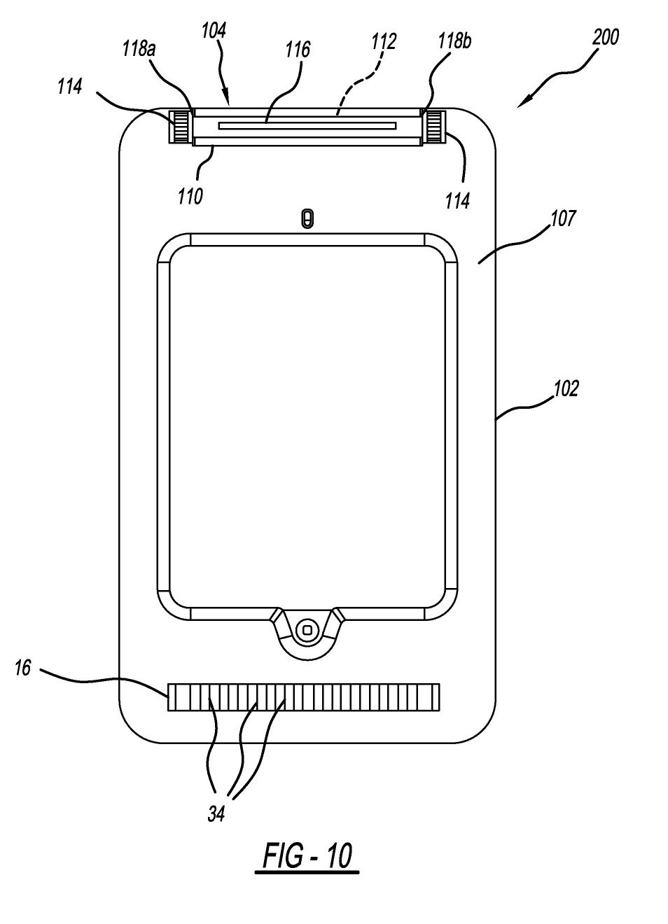

With reference to FIGS. 8-10, another configuration of a device 200 for making a woven article is provided. The device 200 may be substantially similar to the device 100, except as otherwise provided herein. Accordingly, like reference numerals will be used to describe similar parts and features. As illustrated, the device 200 does not include a sensor assembly 106. It will be appreciated, therefore, that a method of operating the device 200 may be substantially similar to the method of operating the device 10.

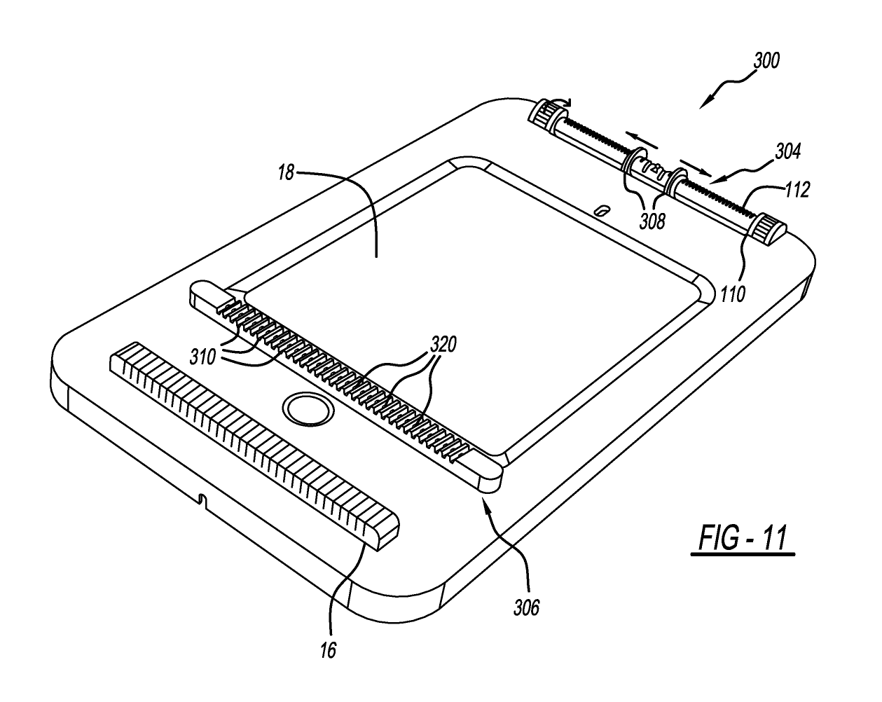

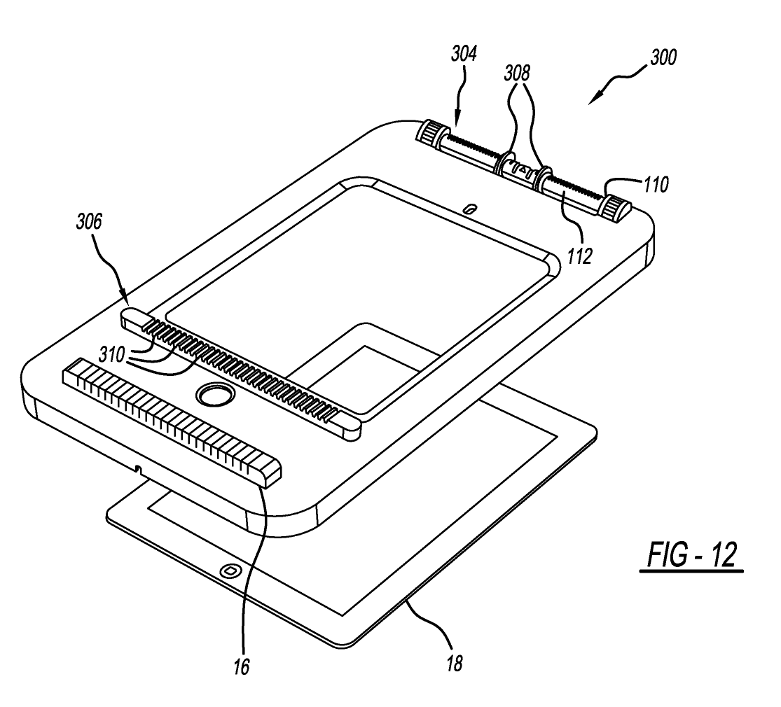

With reference to FIGS. 11-13, another configuration of a device 300 for making a woven article is provided. The device 300 may be substantially similar to the device 100, except as otherwise provided herein. Accordingly, like reference numerals will be used to describe similar parts and features, and similar parts and features will not be described again in detail.

The device 300 may include a first engagement device 304 and a sensor assembly 306. The first engagement device 304 may be substantially similar to the engagement device 104, except as otherwise provided herein. Accordingly, like reference numerals will be used to describe similar parts and features, and similar parts and features will not be described again in detail. The first engagement device 304 may include at least one adjustment mechanism 308. In one configuration, the first engagement device 304 includes two adjustment mechanisms 308. The adjustment mechanism 308 may be slidably disposed about at least one of the hub 110 and the axle 112. Sliding the adjustment mechanism 308 along the hub 110 and/or the axle 112 will ensure that the strings 20 extend from a central portion of the first engagement device 304. In this way, the adjustment mechanisms 308 help to ensure that the weaving process occurs in a central portion of the computing device 18.

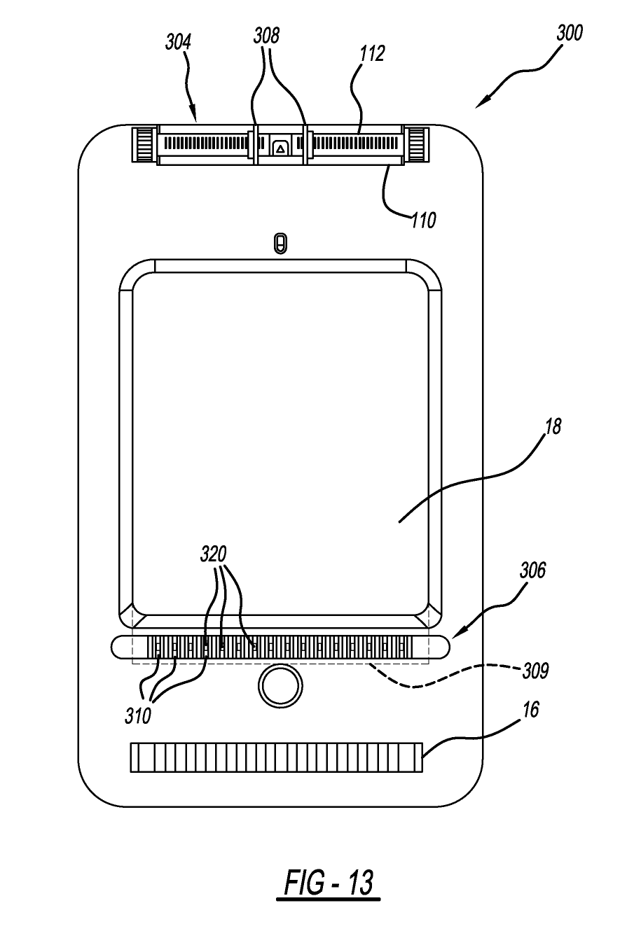

The sensor assembly 306 may be an elongate member fixedly attached to the base 12 and extending in a direction that is substantially perpendicular to the length or the width of the computing device 18. As illustrated, in one configuration, the sensor assembly 306 extends in a direction that is perpendicular to the length of the computing device 18, and is generally aligned with a screen or display 309 of the computing device (FIG. 13) The sensor assembly 306 may include a plurality of channels or slits 310 formed therein. Each of the slits 310 may be operable to removably engage a corresponding one of the strings 20. In one configuration, the slits 310 may cooperate with the first engagement device 304 to hold the strings 20 in a generally taught condition. In other configurations, the second engagement device 16 may cooperate with the first engagement device 304 to hold the strings 20 in a generally taught condition. As illustrated, in one configuration, the slits 310 may be generally parallel to each other and perpendicular to the elongated direction of the sensor assembly 306, such that the slits 310 generally define a single linear pattern. It will be appreciated, however, that in other configurations, the slits 310 may be arranged to define more than one linear pattern. Accordingly, a first plurality of slits 310 may define a first linear pattern and a second plurality of slits 310 may define a second linear pattern. The second linear pattern may be located between the first linear pattern and the second engagement device 16. In this way, the sensor assembly 306 may allow for a greater distance between adjacent slits 310, thus allowing the user more space to manipulate the strings 20.

Each slit 310 may include a through-aperture (not shown) and an actuation element 320. The through-aperture may extend through the slit 310 and be generally aligned with the screen or display of the computing device 18. The actuation element 320 may include capacitive properties, and may include a portion (not shown) extending through the aperture of the slit 310, such that the actuation element 320 is operable to engage the screen or display of the computing device 18. In operation, the string 20 may be placed in the slit 310 and cause the actuation element 320 to contact the screen or display of the computing device 18. In this way, the string 20 and the actuation element 320 may be operable to send a signal to the computing device 18 that a step in the instructions has been completed, thus allowing the computing device 18 to display the next step in the instructions.

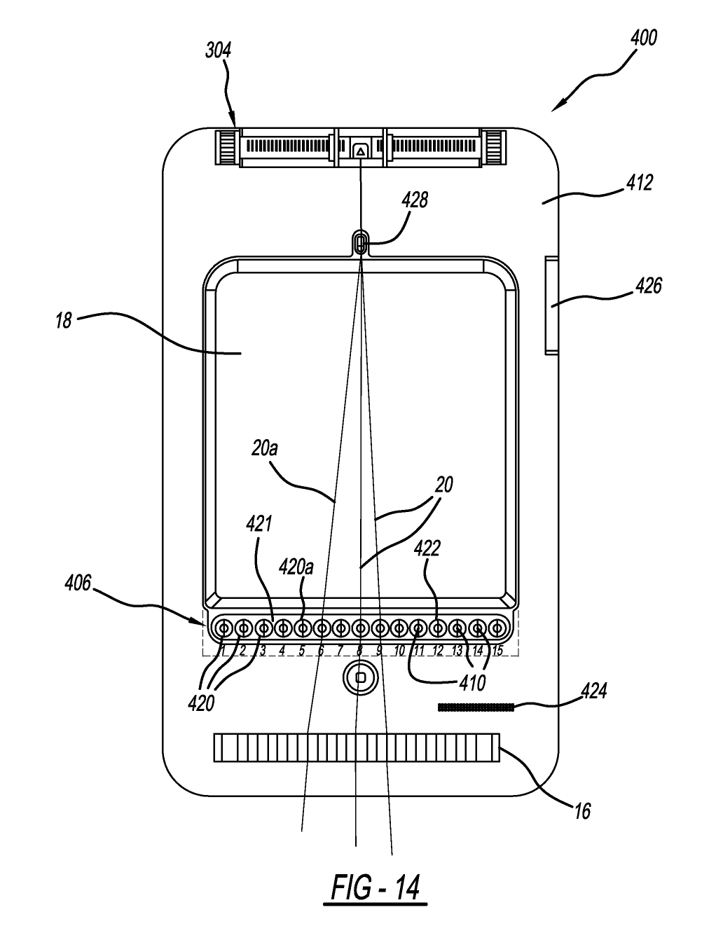

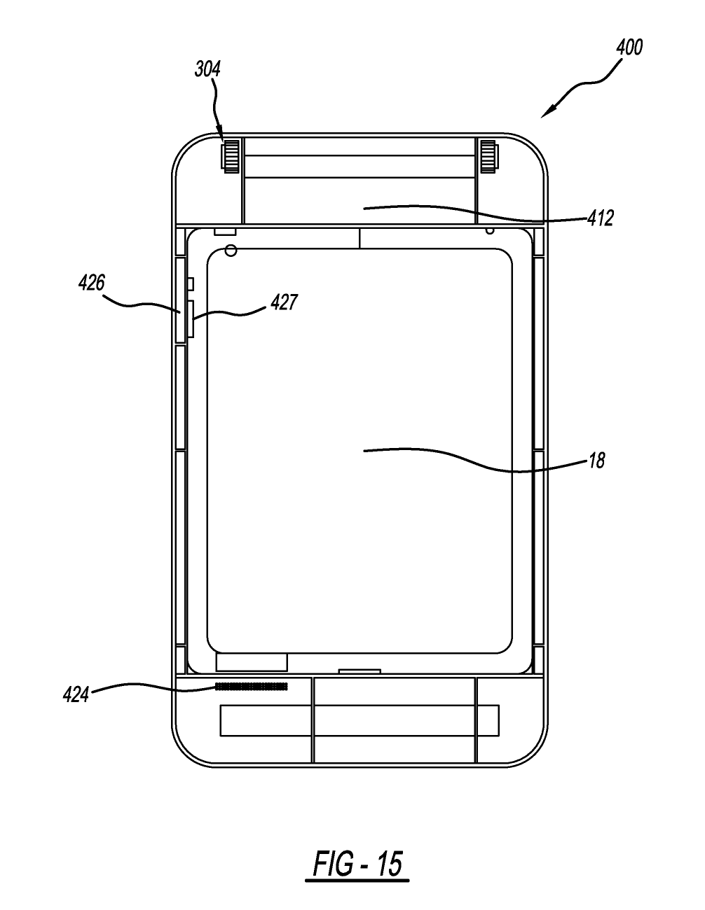

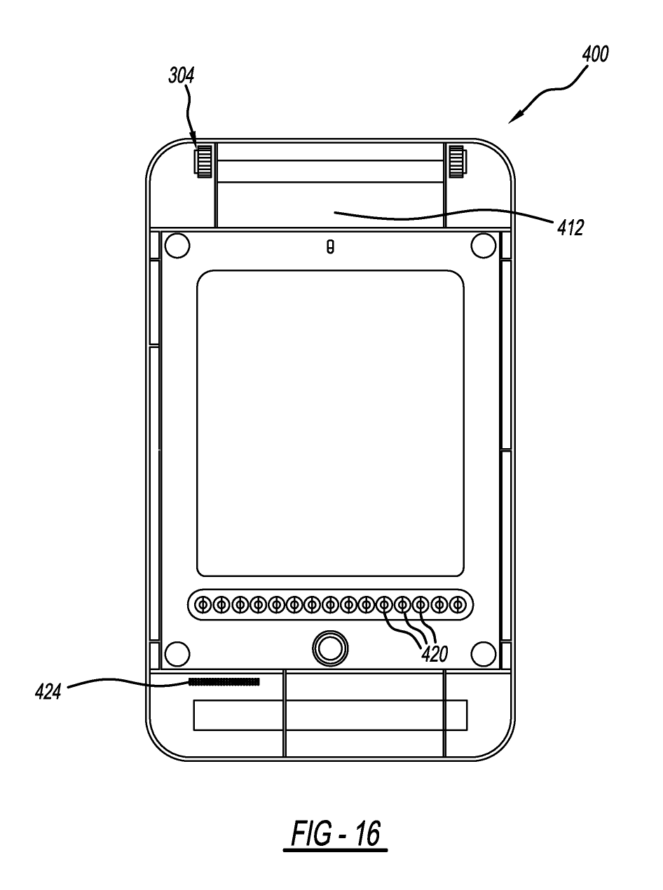

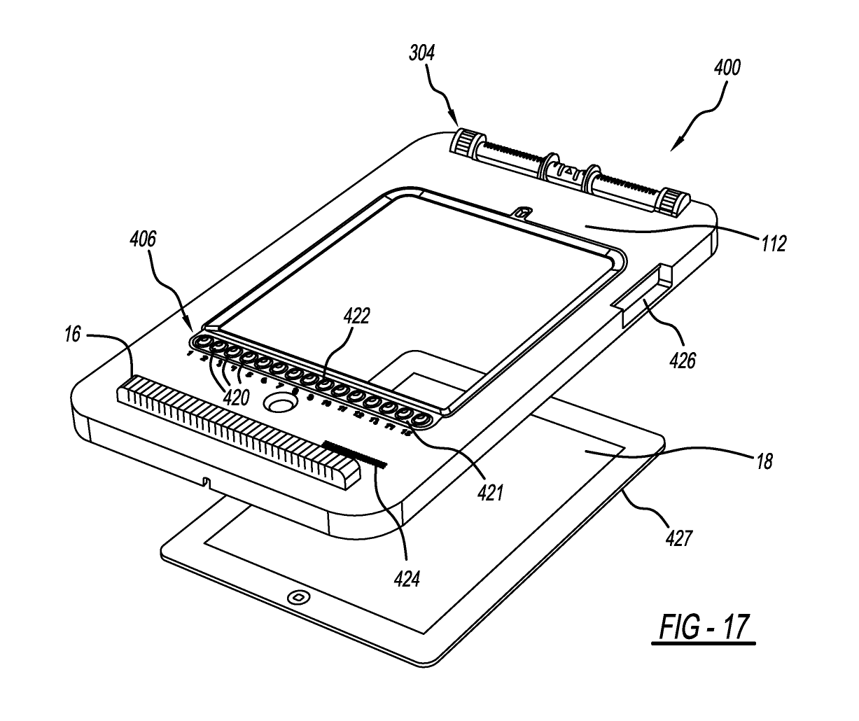

With reference to FIGS. 14-17, another configuration of a device 400 for making a woven article is provided. The device 400 may be substantially similar to the device 300, except as otherwise provided herein. Accordingly, like reference numerals will be used to describe similar parts and features, and similar parts and features will not be described again in detail.

The device 400 may include a sensor assembly 406. The sensor assembly 406 may be substantially similar to the sensor assembly 306, except as otherwise provided herein. The sensor assembly 406 may include a plurality of actuation elements 420. In one configuration, the actuation elements 420 may be interconnected by a webbing 421. In this way, the actuation elements 420 and the webbing 421 may be integrally and monolithically formed. In other configurations, the actuation elements 420 may be discrete and separable from the webbing 421. The actuation elements 420 and the webbing 421 may be aligned with the screen or display of the computing device 18. In this regard, the actuation elements 420 may include a transparent or translucent material, such that the display or screen of the computing device is generally visible through the actuation elements 420 and/or the webbing 421. The actuation elements 420 may also include an outer surface 422. The outer surface 422 may be convex and define a substantially semi-spherical shape. The actuation elements 420 may include an inductive material positioned over the screen or display of the computing device 18. The outer surface 422 of the actuation element 420 may include a slit 410 therethrough. In one configuration, a width of the slit 420 may be such that the slit 410 cooperates with the first engagement device 304 to secure the strings 20 in a generally taught condition. In other configurations, the second engagement device 16 may cooperate with the first engagement device 304 to hold the strings 20 in a generally taught condition.

A base or frame 412 of the device 400 may include an array of apertures 424 and an aperture 426. The array of apertures 424 may allow for generally communicating sound to the user from a speaker (not shown) in the computing device 18. In this regard, the apertures 424 may be located between the second engagement device 16 and the actuation elements 420. The aperture 426 may positioned in the frame 412 to allow the user to manipulate at least one button or control 427 on the computing device 18. An image capturing device 428, such as a camera or a video camera, on the computing device 18 may be generally aligned with at least one of the strings 20, such that the string 20 is viewable by the image capturing device 428.

In operation, the string 20 may be placed in the slit 410 and cause the actuation element 420 to contact the screen or display of the computing device 18. In this way, the string 20 and the actuation element 420 may be operable to send a signal to the computing device 18 that a step in the instructions has been completed, thus allowing the computing device 18 to display the next step in the instructions. It will also be appreciated that the user may push the actuation element 420 into contact with the computing device 18 to send a signal to the computing device that the step in the instructions has been completed. In one configuration, the transparent or translucent properties of the actuation elements 420 and/or the webbing 421 will allow the screen or display of the computing device 18 to send a visual signal to the user that a step in the instructions for creating the woven article has been completed, or that a next step in the instructions is ready for completion. In one example, a particular actuation element 420a corresponding to the next location for a particular string 20a may illuminate, notifying the user to move the particular string 20a to the particular actuation element 420a, and/or notifying the user to press or otherwise actuate the actuation element 420a to signal to the computing device that the particular step in the instructions are complete. When the user completes a step in the instructions for creating the woven article, the image capturing device 428 may capture the location of at least one of the strings 20 relative to the computing device 18 or the frame 412 and communicate the location of such string 20 to the application 36 or other software that is running the instructions for creating the woven article. If the string 20 is not properly aligned relative to the computing device 18 or the frame 412, the software may send an audio or visual signal to the screen or display of the computing device 18, notifying the user of such.

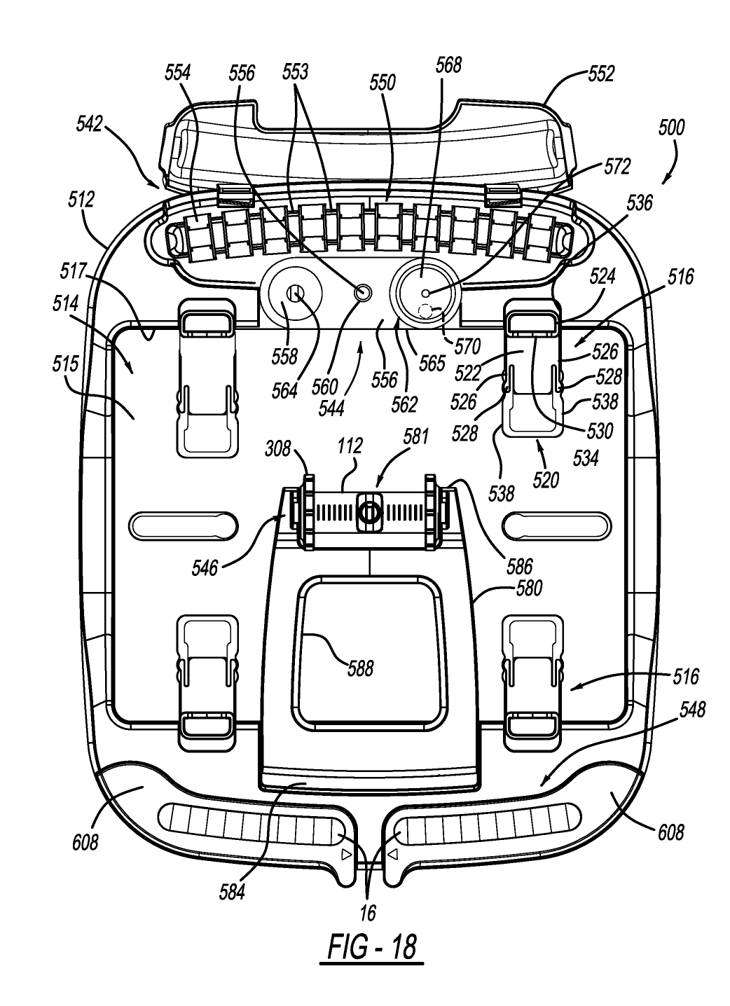

With reference to FIGS. 18-22, another configuration of a device 500 for making a woven article is provided. The device 500 may be substantially similar to any of the previous devices 10, 100, 200, 300, 400, apart from any exceptions described below and/or shown in the figures. Accordingly, like reference numerals will be used to describe similar parts and features, and similar parts and features will not be described again in detail.

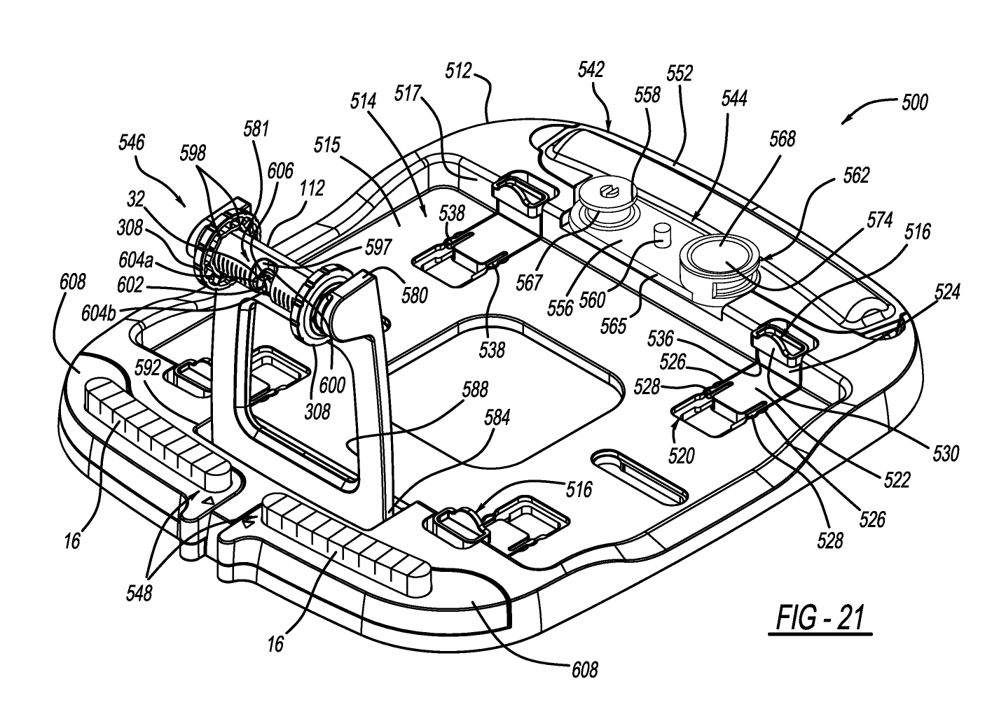

The device 500 may include a housing or frame 512 for securing the computing device 18, such that the computing device 18 is visible in a window or recess 514 of the frame 512. The recess 514 may be defined by a tray 515 and a sidewall 517. The device 500 may include at least one locking mechanism 516 for securing the computing device 18 to the frame 512 and within the recess 514. As illustrated, in one configuration, the device 500 may include four locking mechanisms 516. The locking mechanism 516 may be slidably coupled to, and within, a channel 520 formed in the frame 512 and may be substantially L-shaped. In this regard, the locking mechanism 516 may include a first leg 522 and a second leg 524. The first leg 522 may include opposed tab members 526. Each of the tab members 526 may include a detent 528. The second leg 524 may include a laterally extending lip or flange 530 extending in a direction substantially perpendicular to the second leg 524. As illustrated in FIG. 21, the channel 520 may be similarly L-shaped, including a first portion 534 and a second portion 536. The first portion 534 may be a horizontally extending portion formed in the tray 515. The first portion 534 may further include opposed recesses or divots 538. The second portion 536 may be a vertically extending portion formed in the sidewall 517.

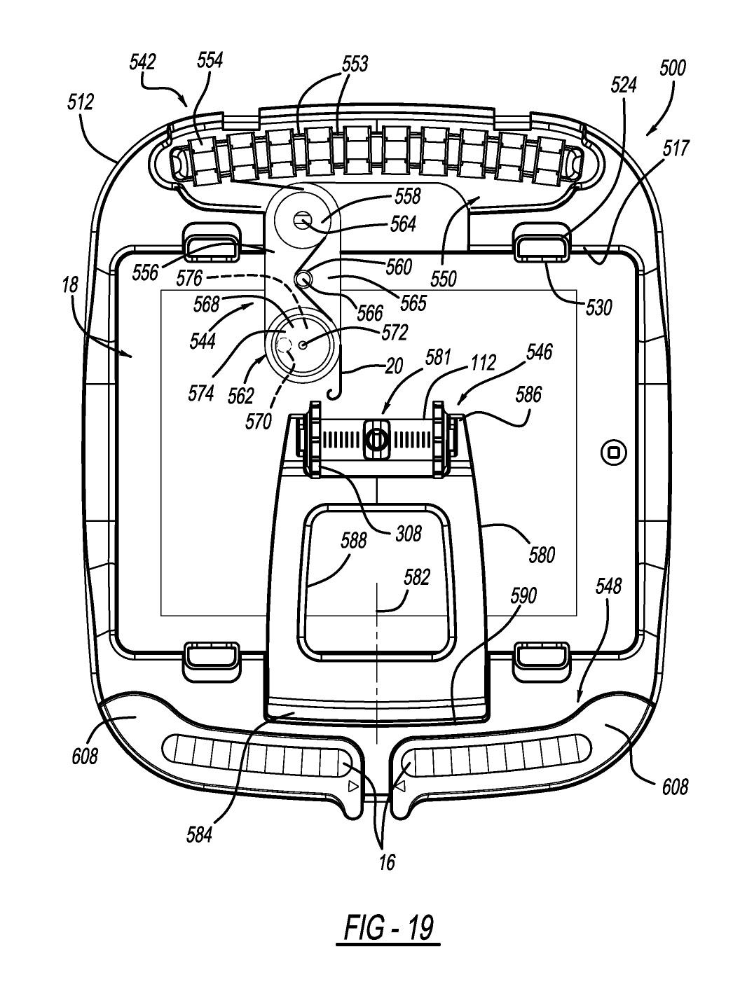

In an assembled configuration, the lock member 518 may be disposed within the channel 520, such that the first leg 522 is slidably disposed within the first portion 534, and the second leg 524 is slidably disposed within the second portion 536. In an unlocked position (FIG. 21), the flange 530 may be substantially aligned with the sidewall 517 of the recess 514, such that the computing device 18 can be placed within the recess 514. In a locked position (FIG. 19) the tab members 526 may bias the detents 528 into engagement with the divots 538, thus securing the lock member 518 in the locked position. In the locked position, the flange 530 may extend over the computing device 18, thus securing the computing device 18 within the recess 514.

The frame 512 may further include a storage system 542, a measuring system 544, a first engagement assembly 546, and a second engagement assembly 548. The storage system 542 may include a compartment 550 and a cover 552. The compartment 550 may be defined by a recessed portion of the frame 512, and may include a plurality of equally spaced divider elements 553. The cover 552 may be pivotably coupled to the frame, such that in a first position (FIG. 18) the user may access the compartment 550. In this regard, the compartment 550 may store a plurality of bobbins 554, or similar supply of strings 20. The bobbins 554 may be located between consecutive divider elements 553, such that an axis of rotation of each bobbin 554 intersects the divider element 553. As such, the user can rotate the bobbin 554 within the compartment 550, and increase the length of the string 20, by pulling the string 20.

The measuring system 544 may include a body 556, a first wheel member 558, a pin member 560, and a sensor or actuation assembly 562. With reference to FIGS. 18 and 19, the first wheel member 558 may be rotatably coupled to the body 556 for rotation about a first axis 564. As illustrated, the first axis 564 may extend substantially perpendicularly from the frame 512 and the body 556. In this regard, the body 556 may be rotatably coupled to the frame 512 for rotation about the first axis 564. In a first position (FIG. 21), the body 556 may be positioned such that a sidewall 565 of the body 556 is substantially aligned with the sidewall 517 of the recess 514. In a second position (FIG. 19), the body may be positioned such that the sidewall 565 is substantially perpendicular to the sidewall 517. In this regard, as will be discussed in more detail below, in the second position, the actuation assembly 562 may be disposed adjacent to, and over, the screen or display of the computing device 18. As illustrated in FIG. 21, a periphery of the first wheel member 558 may include a substantially cylindrical channel 567 formed therein. The channel 567 may extend about the first axis 564.

As illustrated in FIGS. 18 and 19, the pin member 560 may be a substantially cylindrical member extending from the body 556 along a second axis 566. The second axis 566 may be substantially parallel to the first axis 564. As illustrated, in one configuration, the pin member 560 is disposed substantially between the first wheel member 558 and the actuation assembly 562.

The actuation assembly 562 may include a second wheel member 568 and an actuation element 570. The second wheel member 568 may be rotatably coupled to the body 556 for rotation about a third axis 572. As illustrated, the third axis 572 may extend in a direction substantially parallel to the first and second axes 564, 566. The second wheel member 568 may include a first side 574 and a second side 576. As illustrated, the first side 574 may generally opposed the computing device 18, while the second side 576 may generally face the computing device 18. The actuation element 570 may be coupled to the second side 576 of the second wheel member 568, and may be radially offset from the third axis 572. The actuation element 570 may be formed from an inductive material, such that the actuation element is operable to send a signal to the screen or display of the computing device 18. As will be discussed in more detail below, in operation, the actuation assembly 562 may be used to measure the length of the strings 20.

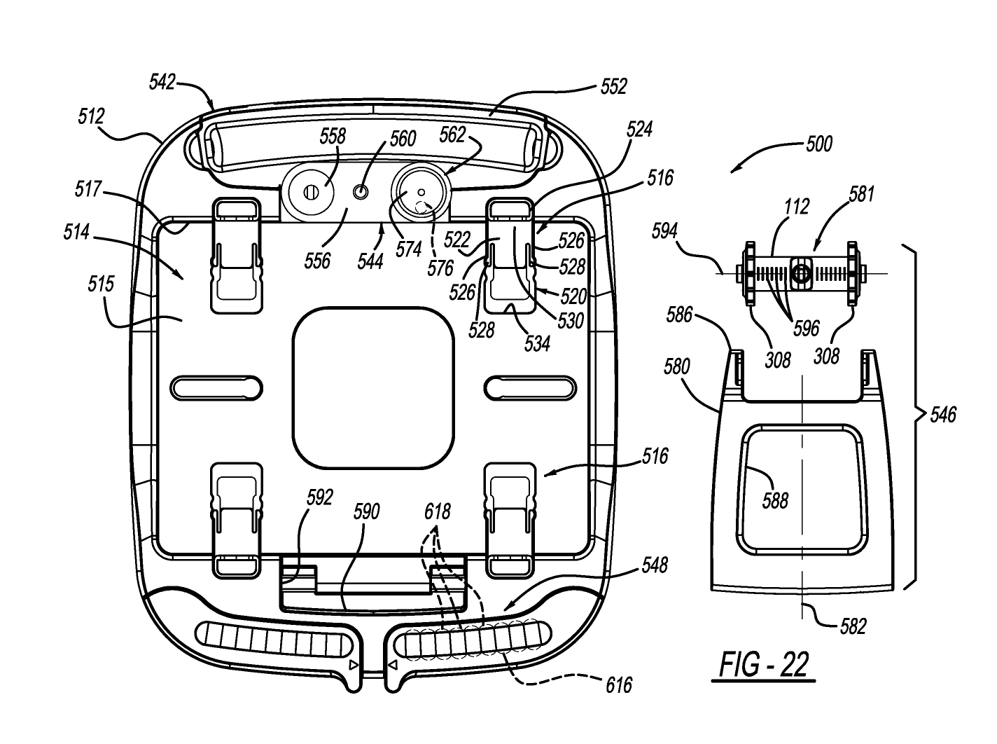

With reference to FIG. 22, the first engagement assembly 546 may include a frame or body 580, the axle 112, the adjustment mechanisms 308, and a first engagement device 581. The body 580 may be a substantially L-shaped member extending along a fourth axis 582 between a first end 584 and a second end 586. The body 580 may define an aperture or window 588 between the first and second ends 584, 586. The first end 584 may be removably coupled to the frame 512. In this regard, the frame 512 may define a second recess 590. The second recess 590 may include a third recess 592 formed therein. In a first position (FIG. 19), the first end 584 of the body 580 may be disposed within the second recess 590, such that the fourth axis 582 is substantially perpendicular to the first axis 564, and such that the body 580 is disposed adjacent to the computing device 18. It will be appreciated that when the body 580 is in the first position, the window 588 may be substantially aligned with the screen or display of the computing device 18. In a second position (FIG. 21), the first end 584 of the body 580 may be disposed within the third recess 592, such that the fourth axis 582 is substantially parallel to the first axis 564. In this regard, the second position may be angularly offset from the first position by an angle substantially equal to ninety degrees. It will be appreciated that when the body 580 is in the second position, the user can access the first recess 514, such that the computing device 18 can be placed, and secured, within the first recess 514.

The axle 112 may be a substantially cylindrical member rotatably and removably coupled to the second end 586 of the body 580, for rotation about a fifth axis 594. The fifth axis 594 may extend in a direction substantially perpendicular to the first axis 564 and the fourth axis 582. The axle 112 may include a plurality of indicia 596 and a channel 597. The indicia 596 may include grooves or ridges, for example, and may be formed on each side of the channel 597 along the fifth axis 594.

The adjustment mechanisms 308 may be slidably coupled to the axle 112. In this regard, as illustrated in FIG. 21, the adjustment mechanisms 308 may include a plurality of teeth 598 that are operable to engage the indicia 596 to secure the adjustment mechanisms 308 to the axle 112 at various positions along the axis 594. As was described above, sliding the adjustment mechanism 308 along the axle 112 will ensure that the strings 20 extend from a central portion of the first engagement device 14. In this way, the adjustment mechanisms 308 help to ensure that the weaving process occurs in a central portion of the computing device 18.

The first engagement device 581 may extend from a first end 600 to a second end 602. The first end 600 may be coupled to the axle 112 within the channel 597. As illustrated, the first engagement device 581 may be substantially similar to the post 28. In this regard, the first engagement device 581 may include the slot 32, defining first and second legs 604a, 604b of the first engagement device 581. The second end 602 of the first engagement device 581 may include a flange or lip 606. As will be explained in more detailed below, the user may utilize either or both of the lip 606 and the slot 32 to secure the strings 20 to the axle 112.

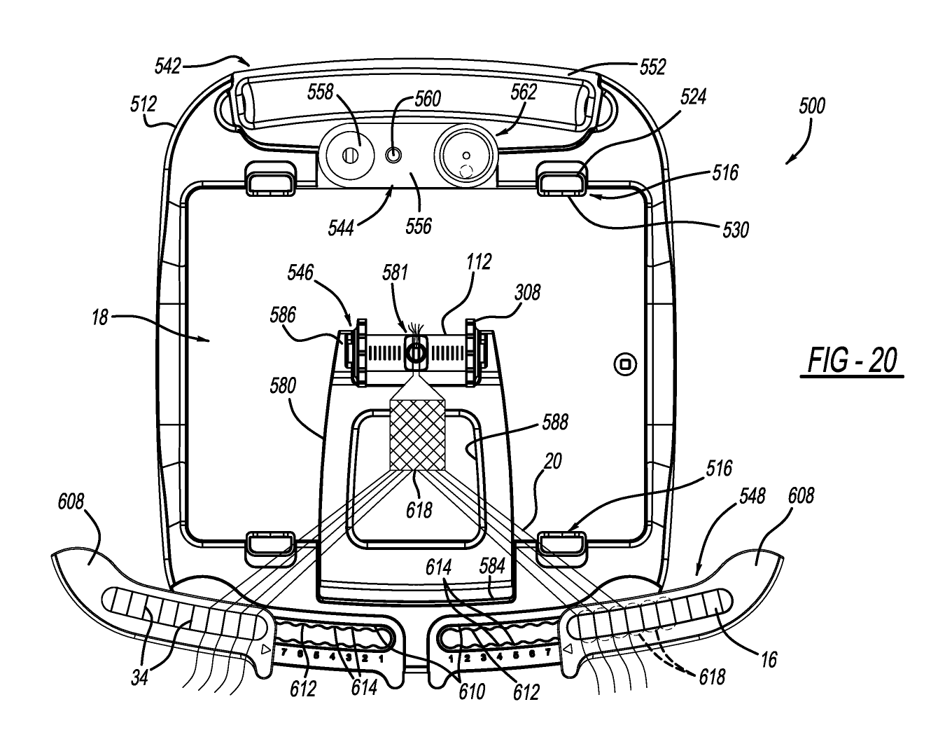

The second engagement assembly 548 may include a body 608 and the second engagement device 16. As illustrated, in one configuration, the device 500 may include two second engagement assemblies 548. The second engagement assembly 548 may be slidably coupled to the frame 512. In this regard, as illustrated in FIG. 20, the frame 512 may include a fourth recess 610 and a fifth recess 612. The fifth recess 612 may be formed within the fourth recess 610, and may include a plurality of first notches 614 formed therein. The first notches 614 may form a substantially sinusoidal pattern. As illustrated in FIG. 22, the body 608 may include a projection 616 having a plurality of second notches 618 formed therein. The second notches 618 may be substantially identical to the first notches 614. In this regard, in an assembled configuration, body 608 may be disposed within the fourth recess 610 such that the projection 616 is disposed within the fifth recess 612. In this configuration, the first notches 614 may engage the second notches 618, such that the body 608 can slide within the fourth recess 610 between a plurality of discrete positions relative to the frame 512 (FIG. 20).

Operation of the device 500 will now be described in more detail. In a first step, the user may place the first end 584 of the body 580 within the third recess 592 (FIG. 21), such that the computing device 18 can be placed within the recess 514. The user may then remove the first end 584 of the body 580 from the third recess 592, and thereafter place the second end 586 of the body 580 within the second recess 590 (FIG. 19). To secure the computing device 18 within the recess 514, the user may slide or otherwise move the lock member 518 within the channel 520, such that the detents 528 engage with the divots 538, and the flange 530 is disposed over, and/or engages, the computing device 18.

With the computing device 18 secured to the frame 512, the user can rotate the body 556 of the measuring system 544 about the first axis 564, and into the second position (FIG. 19). The user can then extend a string 20 from a bobbin 554. The string 20 can be fed through the first and second wheel members 558, 568 and the pin member 560, such that the string engages the second wheel member 568. The user can then apply a force on the second wheel member 568 in a direction substantially parallel to the first axis 564 (e.g., by pressing on the second wheel member 568 with a finger), such that the actuation element 570 engages the screen or display of the computing device 18. As the user pulls the string 20, the string causes the second wheel member 568 to rotate about the third axis 572. In this regard, a peripheral surface of the second wheel member 568 may include a rubberized or other suitable gripping material otherwise known in the art, to allow the string 20 to grip, and cause the rotation of, the second wheel member 568. As the string 20 causes the second wheel member 568 to rotate, the radially offset actuation element 570 travels or otherwise moves along the screen or display of the computing device 18 a distance D. As the second wheel member 568 rotates, and the actuation element 568 moves along the screen, the computing device 18 can sense and calculate the value of the distance D. The value of the distance D can be displayed on the screen of the computing device 18, such that the user can obtain a desired length of string 20. The user can then repeat this process with any number of strings 20 and bobbins 554.

Once the user has obtained the desired number and length of strings 20, the user can secure the first ends 24 of the strings 20 to the first engagement device 581 of the first engagement assembly 546. In this regard, the user may secure the first ends 24 within the slot 32 by tying a knot in the first ends 24 of the strings 20. Alternatively, the user may secure the strings 20 between the axle 112 and the lip 606 of the first engagement device 581 by looping the first ends 24 of the strings 20 about the first engagement device 581.

The user can secure the strings 20 within the slits 34 of the second engagement device 16, prior to and during the weaving process. During the weaving process, the user may follow a set of instructions or template provided by the computing device 18. As the user is weaving the woven article, the user can rotate the axle 112 about the fifth axis 594, such that a weaving location 618 is aligned with the window 588 of the first engagement assembly 546 relative to a first direction (FIG. 20). In this regard, the user may also slide or otherwise move the adjustment mechanisms 308 relative to the axle 112 to ensure that the weaving location 618 is aligned with the window 588 relative to a second direction that is substantially perpendicular to the first direction. If the user desires to change or otherwise vary the spacing between the string 20, the user can slide the body 608 can slide within the fourth recess 610 such that the first notches 614 engage the second notches 618 in one of the plurality of discrete positions, relative to the frame 512.

The removable coupling of the axle 112 to the body 580, and the removable coupling of the body 580 to the frame 512 allows a user, or multiple users, to weave a second woven article before the user has finished weaving a first woven article. In other words, by removing the axle 112 from the body 580, and/or removing the body 580 from the frame 512, the user (or multiple users) switch back and forth between the weaving of multiple woven articles prior to completing any of the woven articles.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A device for making a woven article from a plurality of strings, the device comprising:
a housing;
a computing device supported by the housing, the computing device including a display;
a first engagement device coupled to the housing and operable to engage a plurality of strings; and
a sensor assembly coupled to the housing and operable to engage the computing device;
wherein the display is operable to communicate instructions for manipulating the plurality of strings.

2. The device of claim 1, wherein the sensor assembly is operable to sense a location of each of the strings relative to the computing device.

3. The device of claim 1, wherein the sensor assembly is operable to sense a length of each of the plurality of strings.

4. The device of claim 1, wherein the sensor assembly includes a wheel member and an actuation element, the wheel member operable to rotate about a first axis, and the actuation element supported by the wheel member and radially offset from the first axis.

5. The device of claim 1, wherein the actuation element is operable to contact the display.

6. The device of claim 4, wherein the sensor assembly further includes a body member, the body member rotatably coupled to the frame for rotation about a second axis substantially parallel to the first axis.

7. The device of claim 6, wherein the wheel member is rotatably coupled to the body member for rotation about the first axis.

8. The device of claim 1, wherein the first engagement device is slidably supported by the housing.

9. The device of claim 1, further comprising a second engagement device supported by the housing, the second engagement device operable to engage the plurality of strings.

10. The device of claim 9, wherein the second engagement device includes a frame and an axle, the housing operable to support the frame in a first position and a second position.

11. The device of claim 10, wherein the first position is offset from the second position by an angle substantially equal to ninety degrees.

12. The device of claim 9, further comprising first and second adjustment mechanisms slidably disposed about the axle.

13. The device of claim 10, wherein the axle is removably coupled to the frame.

14. The device of claim 1, further comprising a locking mechanism for securing the computing device to the frame.

15. A device for making a woven article from a plurality of strings, the device comprising:
a housing;
a computing device supported by the housing, the computing device including a display;
a first engagement device including a frame and an axle, the frame removably coupled to the housing, the axle removably and rotatably coupled to the frame and operable to engage a plurality of strings; and
wherein the display is operable to communicate instructions for manipulating the plurality of strings.

16. The device of claim 15, further comprising a sensor assembly coupled to the housing, the sensor assembly operable to engage the computing device.

17. The device of claim 16, wherein the sensor assembly is operable to sense a location of each of the plurality of strings relative to the computing device.

18. The device of claim 16, wherein the sensor assembly is operable to communicate a distance to the computing device.

19. The device of claim 18, wherein the distance is substantially equal to a length of at least one of the plurality of strings.

20. The device of claim 18, wherein the sensor assembly includes a wheel member and an actuation element, the wheel member operable to rotate about a first axis, and the actuation element supported by the wheel member and radially offset from the first axis.
